(19) United States
(12) Patent Application Publication
(10) Pub. No.: US 2005/0191891 A1
(43) Pub. Date: Sep. 1, 2005

(54) Domestic electrical appliances

(76) Inventor: Edward Joseph Khoury, Perth (AU)

Correspondence Address: D. PETER HOCHBERG CO. L.P.A., 1940 EAST 6TH STREET, CLEVELAND, OH, 44114, US

(21) Appl. No.: 11/040,355

(22) Filed: Jan. 21, 2005

(30) Foreign Application Priority Data
Jan. 22, 2004 (AU) 2004900278

(51) Int. Cl. H01R 13/627

(52) U.S. Cl. 439/357

(57) ABSTRACT

A utilisation member which may be a domestic appliance or an intermediary member is provided. It has a recess in its base to receive a cordless connector. Inter engaging connection means are provided respectively on a connector unit carrying the cordless connector and in the recess so that when the utilisation member is attached to the connector unit a firm coupling is formed holding the appliance to the connector unit. The interengaging means may comprise a bayonet connection or may consist of clips on the connector unit fitting into recesses in the appliance.

### FIELD OF INVENTION

This invention relates to domestic electrical appliances.

### BACKGROUND TO THE INVENTION

The invention is concerned with such an appliance, that is used with a connector unit including an electrical connector to which the appliance is attached to establish electrical connection. Such an appliance is hereinafter referred to as a cordless appliance. Typical of such cordless appliances are described in for example WO 02/97927 and similar specifications. In known cordless appliances such attachment, normally takes place freely and easily usually by just lifting the appliance. The invention is also concerned with intermediary members located between the connector and of the cordless appliance to which the cordless appliance may even be freely and easily attached to establish electrical connection with a power source. Typical of such intermediary members are those shown in FIGS. 2, 4, 5, 6 and 7 of WO 02/97927

In this specification the term “domestic appliance” is intended to mean, unless the context indicates to the contrary, a kettle, a blender, a toaster, a percolator or the like item as found in a modern kitchen. The term “utilization member” as used herein incorporates a domestic appliance and an intermediary member as mentioned above.

### SUMMARY OF THE INVENTION

According to one aspect of invention of those provided the combination of a connector unit and a utilisation member having a recess therein, normally in its base, to receive the connector, wherein inter engaging connection means are provided respectively on the connector unit and utilisation member, so that when the utilisation member is attached to the connector unit, the connection means form a firm coupling holding the appliance to the member. The term “firm coupling” as used herein is intended to mean to include with in its scope, any coupling that requires a special operation, whether or not requiring the use of tools, for separating the parts as so coupled as opposed to merely lifting the utilisation member or appliance as in known arrangements as described above.

In one arrangement of the invention one of the connection means, normally that on the connector is provided with outwardly sprung clips and the other comprises recesses to receive such clips. The clips are conveniently formed with enlarged heads that engage in enlargements at the end of the recesses. Such engagement is preferably a positive engagement that prevents the clips being withdrawn from the recess without being moved inwardly to move the head from the enlargement.

In another arrangement of the invention, the connection means comprises a bayonet connection having inter engaging bayonet parts which can engage when the appliance is applied to the connector and which move into a locking position on relative rotation of the parts thereafter. The bayonet parts preferably comprises bayonet clips carried by one of the connection means, normally the connector unit, and openings in the other connection means into which they clip in any engage.

In a further arrangement of the invention the connection means comprises frictionally engaging parts, which require a special effort, normally by holding both the utilisation member and the connector unit, to remove one from the other.

According to other aspect of the invention there is provided a connector unit, having connection means thereon, for engagement with corresponding connection means on the utilisation member. According to a further aspect of the invention there is provided an utilisation member having connection means of thereon for engagement with connection means on the connector unit.

Embodiments of the invention will now be described by way of example with reference to the accompanying drawings.

### SHORT DESCRIPTION OF DRAWINGS

FIG. 1 is a side view (partially broken away) of a toaster and a cordless connector unit to which it is about to be connected,

FIG. 2 is an enlarged view of a detail of the base of the toaster and of the connector unit,

FIG. 3 is a view similar to FIG. 2 showing of the connector unit in position and attached to the utilisation member to form a firm coupling thereto,

FIG. 4 is a perspective view of the connector unit,

FIGS. 5, 6 and 7 are respectively, a plan view, an end view, and a side view of a modified connector unit of the invention,

FIG. 8 is a detail, perspective view of the base of a utilisation member of the invention and the connector unit of FIG. 5 immediately prior to engagement,

FIG. 9 is a view similar to FIG. 8 showing the connector in engaging the base, and

FIG. 10 shows the position of the aforesaid parts after relative rotation between the connector and the utilisation member to hold the parts firmly in connection.

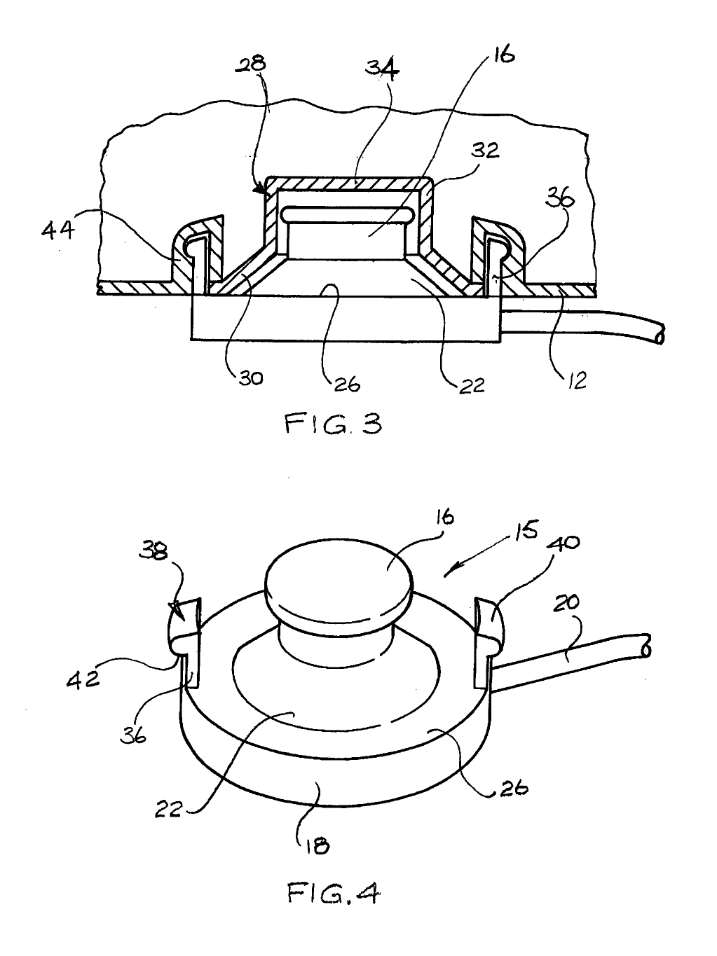

Referring now to FIGS. 1 to 3 there is shown a cordless domestic appliance 10, in the form of a toaster, having a base 12, and being formed with supporting feet 14 whereby it can be mounted on a working surface. Also shown is a connector unit 15 comprising a cylindrical cordless connector 16 (indicated diagrammatically) concentrically mounted on a moulded plastic base 18 that is connected by means of a cord 20 to a source of electrical power (not shown) The connector 16 is a conventional device of the kind presently made by Strix Limited, Otter Limited and Ketsol Limited among others, and typically is of that described and claimed in British patent specification number GB 2318926. The connector 16 is mounted on a frusto-conical part 22 rising from the base 18. There is an annular surface 26 on the base 18 surrounding the lower portion of the part 22.

In the base 12 of the toaster 10, there is a circular opening with a moulded receiver unit 28 formed therein and bonded thereto. The unit 28 comprises a frusto-conical lead-in portion 30 leading to a cylindrical end 32. The lead-in portion 30 and end 32 are dimensioned to receive snugly therein the connector 16 and the frusto-conical part 22 of the connector unit 15 respectively. The base 34 of the end 30 is shown in the drawings as being closed but in practice is normally open to contain the parts (not shown) in of the appliance 10 that co-operate with the connector 16 to enable electrical connection to be made with the connector.

Mounted at diametrically opposed positions on surface 26 of the base 18 are a pair of slightly resilient upstanding clips 36. Each clip 36 has an enlarged “half-arrow shaped” head 38 with inclined outer top surfaces 40 and an upwardly inclined undersurface 42. On diametrically opposite sides of the opening are two axially extending members 44 each having an elongated recess 46 in which the clips 36 including the heads 38 (when inwardly inclined) can be received. An enlargement 48 is provided at the inner end of each recess 46. The enlargement has an outer upwardly facing surface 50 and is shaped to receive the head 38 with the under surface 42 resting on the surface 50 to hold the head firmly to prevent it from being withdrawn from the recess.

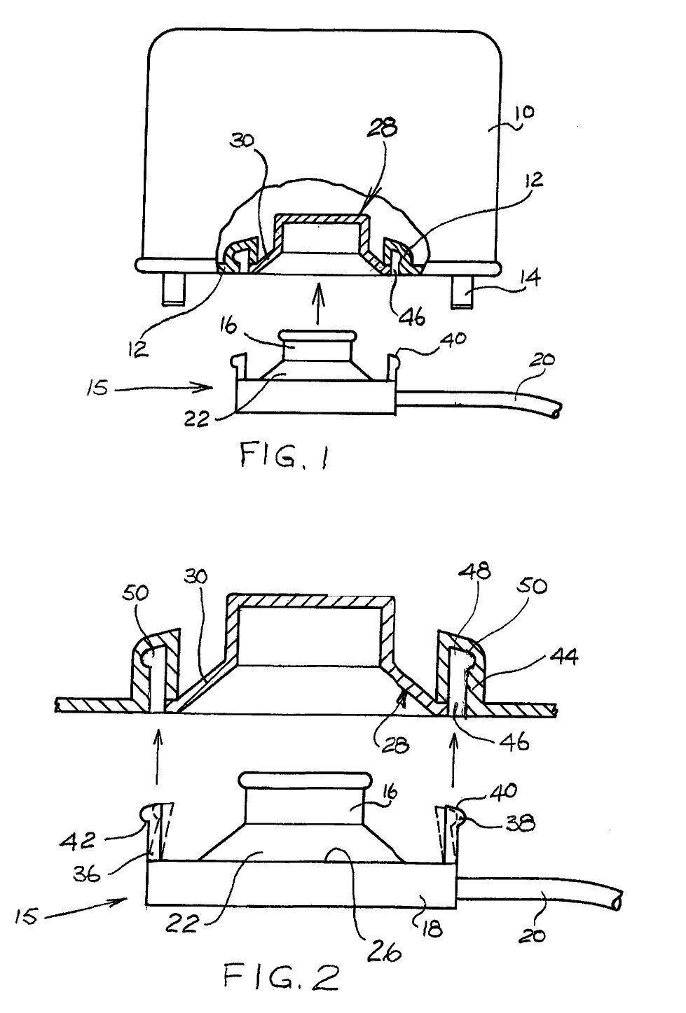

In use, the appliance 10 is located above the connector unit 15 and moved axially downwardly on to the connector 16 (see FIGS. 1 and 2). On such movement, the outer edge of the mouth of each recess 46 engages the inclined surface 40 of the head 38 deflecting the clips 36 inwardly (as shown in dotted lines in FIG. 2) to permit the heads 38 to enter the recesses 46. On further relative movement of the appliance 10 and the connector unit 15, the heads 38 reach the enlargements 48 at the inner ends of the recesses 42 and spring outwardly to engage therein. The cordless connector 16 is positively firmly connected to the appliance 10 by the engagement of the surfaces 2 and 50. It cannot be removed therefrom, unless the clips 36 are deflected inwardly, so that the surfaces 42 are free of the surfaces 50 of the enlargements 48. This can normally only be done by pulling on the connector unit to exert a sufficient force for the clips 36 to be deflected inwardly by the shape of the surfaces 42 and 50. Alternatively a special tool (not shown) may be provided for this purpose. As can be seen this connection constitutes a firm coupling, as mentioned above.

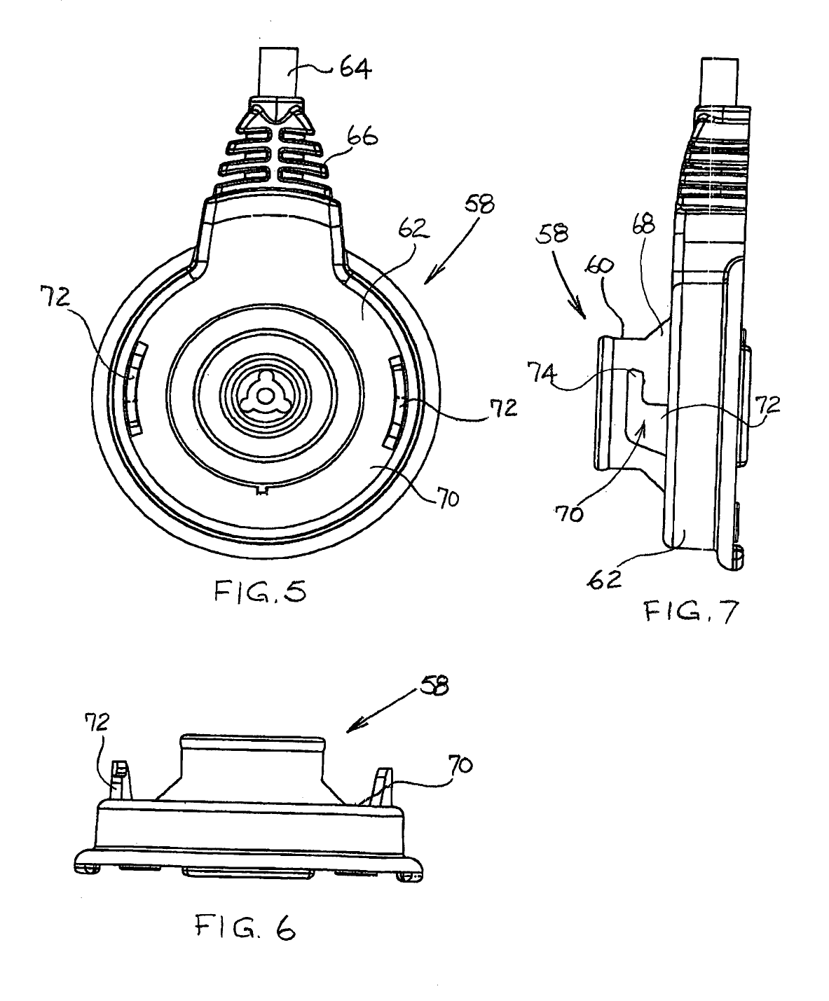

Reference is now made to FIGS. 5, 6 and 7 wherein is illustrated a modified connector unit 58 incorporating a connector 60 on a moulded plastic base 62 into which electrical wires in a cable 64 enter through a connecting piece 66 integral with the base 62. The connector 60 is mounted on the base 62 by means of a frusto-conical support portion 68. There is an annular top surface 70 on the base 62. On diametrically opposed positions on the surface 70 are bayonets clips 72. Each clip 72 is arcuate in plan and has inward extension arms 74 at its upper end.

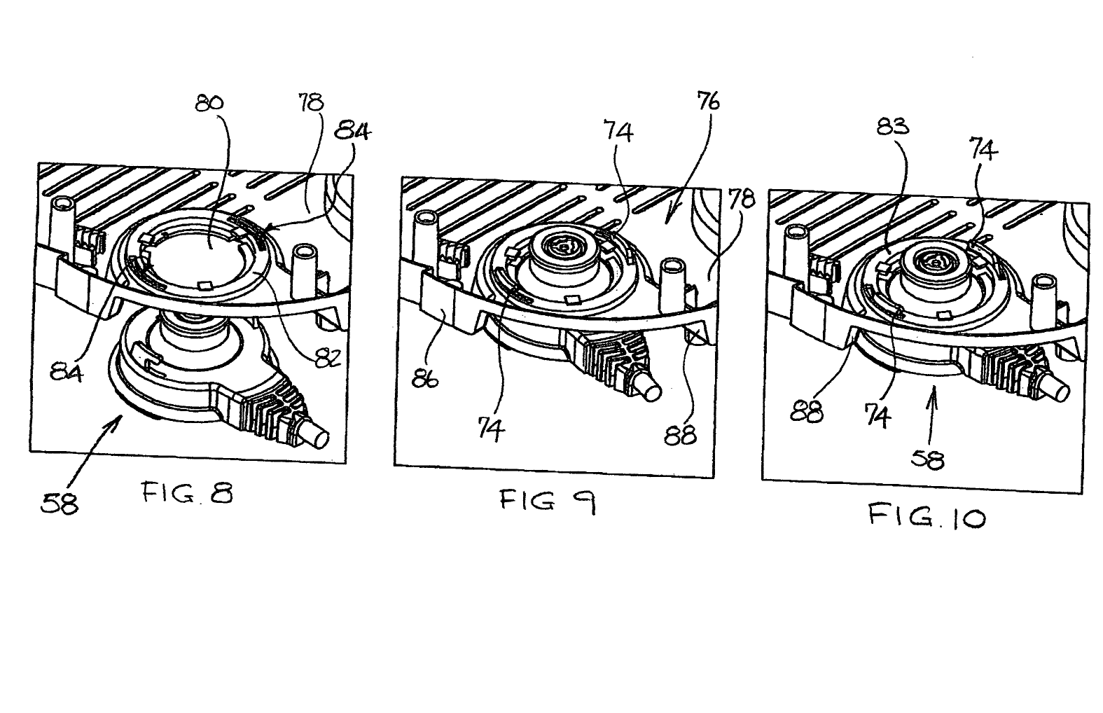

The connector unit 58 is used with a utilisation member 76, a part of the base 78 of which is shown in FIGS. 8, 9 and 10. Typically, this utilisation member 76 is an intermediary member such as that shown in FIG. 2 of WO 02/97927 being a plate having a connector thereon on to which a cordless domestic appliance such as a kettle can be placed for normal use. In the base 78 and near one side is a circular opening 80, which is surrounded by an annular ring 82 of approximately the same dimensions as the surface 70. The top portion of the utilisation member 76 (not shown) contains a receiving member corresponding to the connector 60 to engage the latter so that electric power can be transferred therefrom to the utilisation member. Formed in that the annular ring 82 at diametrically opposed position are two arcuate slots 84 the length of which is slightly greater than the length of the extension arms 74.

Below the base 70, the utilisation member 76 has a downwardly depending peripheral rim 86 which provides a support for the utilisation member 76 whereby it may be mounted on a work surface. Formed in the skirt 86 directly below the opening 82 is a recessed portion 88. The size of the recessed portion 88 is such that the connector unit 58 can be inserted therein and can be rotated as will be described.

In use, utilisation member 76, is placed so that the opening 80 is above the connector unit 58 in such a way that the clips 72 are located below the openings 84. The utilisation member 76 is now lowered on to the connector unit 58 and the connector 60 engages the receiving member. At the same time the extension arms 74 of the clips 72 pass through the openings 84, as shown in FIG. 9. The connector unit 58 is now rotated through a small angle into the position as shown in FIGS. 10, i.e. the connector 66 is swung about the axis of the opening 80. When this occurs, the extension arms 74 of the clips 72 move along the arcuate slots 84 so that the extension arms 74 rest on the base 86 of the ring 82. The connector unit 58 is now firmly attached to the utilisation member 76. The utilisation member 76 can only be removed from the connector unit 58 by the positive step of rotating the connector unit 58 relative to the utilisation member 76, so that the extension arms 74 are wholly over the openings 84 and can be removed therefrom. It will thus be seen that when attached there is a positive connection between the unit 58 and the utilisation member 76 and such a connection constitutes a firm coupling as mentioned above.

The invention is not limited to the precise constructional details hereinbefore described and illustrated in the drawings. For example, the base 78 described above may be the base of a cordless domestic appliance. The position of the opening 80 in the base 78 may be varied as desired. The receiver units 28 may be moulded integrally with the base 12 instead of being separate as shown.

Instead of the positive connections, as in the described embodiments, by appropriate shaping of the connector unit, the frusto-conical part and the base, with the corresponding parts of the utilisation member or appliance, there may be a frictional engagement between these two parts such as will require a positive step to separate the members; requiring gripping both of the utilisation member and of the support unit. This then constitutes a firm coupling as mentioned above.

It will be seen that the arrangements described above provide a permanent or semi-permanent connection of a utilisation member (which may be an intermediary member or a domestic cordless appliance) to a connection unit if this is required or convenient. Furthermore the domestic cordless appliance as described herein can be used with known connecting units such as described in WO 02/097927 for easy connection and disconnection.

The appliance may be any domestic appliance such a kettle, a blender, a toaster, a percolator or the like item as found in a modern kitchen.

It is appreciated that certain features of the invention, which are, for clarity, described in the context of separate embodiments may also be provided in combination in a single embodiment. Conversely various features of the invention which are for brevity described in the context of a single embodiment may also be provided separately or in any suitable combination. Without derogating from the generality of the forgoing, it will be understood that the appliances may be modified to accommodate the connector unit 58 so that it can be used therewith and also the intermediary member may be modified to accommodate the connector unit 15 to be used therewith.

1. The combination of a connector unit and a utilisation member having a recess therein to receive the connector unit, wherein interengaging connection means are provided respectively on the connector unit and appliance, so that when the utilisation member is attached to the connector unit, the connection means form a firm coupling holding the utilisation member to the connector unit.

2. The combination of claim 1 wherein the recess is formed in the base of the utilization member.

3. The combination of claim 1 wherein one of the connection means is provided with outwardly sprung clips and the other comprises recesses to receive such clips.

4. The combination of claim 3 wherein the clips are provided on the connector unit.

5. The combination of claim 3 wherein the clips are formed with enlarged heads that engage in the recesses in such a way that there is a positive connection between a surface at the recess and a surface on the head to positively prevent the head being removed therefrom.

6. The combination of claim 1 wherein the connection means comprises a bayonet connection having interengaging bayonet parts which can engage when the utilisation member is applied to the connector unit and which move into a locking position on the relative rotation of the parts thereafter.

7. The combination of claim 6 wherein the bayonet parts comprise bayonet clips carried by one of the connection means and the recesses are openings into which the clips in may engage.

8. The combination of claim 7 wherein the bayonet clips are carried on the connector.

9. The combination of claim 1 wherein connection made comprises frictionally engaging parts which require a special effort to remove one from the other.

10. The combination of claim 1 wherein the utilisation member is a cordless domestic appliance.

11. The combination of claim 1 wherein the utilisation member is an intermediary member.

12. A connector unit for use in the combination as claimed in claim 1 having connection means thereon for engagement with corresponding connection means on the utilisation member.

13. A utilisation member for use in the combination as claimed in claim 1 having connection means thereon for engagement with connection means on the connector unit.

14. A utilisation member as claimed in claim 13 comprising a domestic appliance.
